(19) United States
(12) Patent Application Publication
(10) Pub. No.: US 2017/0191233 A1
(43) Pub. Date: Jul. 6, 2017

(54) Road Marking Scan and Transfer System

(71) Applicant: Caterpillar Paving Products Inc., Brooklyn Park, MN (US)

(72) Inventor: Michael P. Barros, Minnetonka, MN (US)

(73) Assignee: Caterpillar Paving Products Inc., Brooklyn Park, MN (US)

(21) Appl. No.: 14/988,279

(22) Filed: Jan. 5, 2016

(51) Int. Cl. E01F 9/50; E01C 23/088; G06K 9/00; E01C 19/00

(52) U.S. Cl. CPC E01F 9/50; E01C 19/004; E01C 23/088; G06K 9/00798

(57) ABSTRACT

A system for applying roadway markings to roadways, including at least one imager for acquiring image data of original roadway markings on an original roadway surface. A first vehicle marking controller receives and stores the image data in combination with acquired location data associated with the original roadway markings. One or more milling tools mill the original roadway surface and create a milled surface. The one or more milling tools are positioned behind the at least one imager relative to a direction of travel. A first vehicle marking module is responsive to the first vehicle marking controller for applying roadway markings based on the location data of the original roadway markings and the image data, the first vehicle marking module positioned behind the one or more milling tools relative to a direction of travel.

### TECHNICAL FIELD

This disclosure relates generally to systems and methods for applying roadway markings to roadways.

### BACKGROUND

Commonly used methods for applying roadway markings to roads after a mill-and-overlay job are time consuming and primitive. Typically, ground crews manually place offset stakes on the shoulder of the road to mark the location of road markings present on the original roadway such as centerlines, and turn lane markings and other features, using a tape measure. In many cases, an appreciable time passes between road milling and road marking re-deposition on the roadway. During this time, vehicle traffic typically continues to drive on the milled surface, forcing drivers to use temporary road markings, which are manually applied to the milled surface using spray paint and the offset stakes as a reference. After paving is complete, new markings are applied to the new asphalt using the same or a similar manual procedure. During the final application of thermoplastic paint, the striping truck uses these spray paint marks as a guideline to approximate the location of the new centerline.

A road surface marking is any kind of device or material that is used on a road surface to signal official roadway information to drivers. Road surface markings are also applied in facilities used by vehicles to mark parking spaces or designate areas for other uses. Road surface markings are also used on paved roadways to provide guidance and information to vehicular users and pedestrians.

Uniformity and proper placement of the markings is an important factor in minimizing confusion and uncertainty about their meaning. Past efforts have been made to standardize such markings across borders. However, different countries and different areas within a country may often categorize and specify road surface markings in different ways. Road surface markings can be mechanical, non-mechanical, or temporary. They can be used to delineate traffic lanes, inform motorists and pedestrians, serve as noise generators, or awaken a sleeping driver when installed in the shoulders of a road. Road surface marking can also indicate parking and stopping positions.

There is continuous effort to improve the road marking systems. Past efforts have included adding retro-reflectivity, increasing longevity, and lowering installation cost. The diversity of existing road surface markings and the continuous development of new road surface markings require training, knowledge, and significant skills on the part of roadway marking specialists. There is a continuous need for improvements in efficient placement of road markings.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In one aspect, the present disclosure describes a system for applying roadway markings to roadways, including at least one imager for acquiring image data of original roadway markings on an original roadway surface. A first vehicle marking controller receives and stores the image data in combination with acquired location data associated with the original roadway markings. One or more milling tools mill the original roadway surface and create a milled surface. The one or more milling tools are positioned behind the at least one imager relative to a direction of travel. A first vehicle marking module is responsive to the first vehicle marking controller for applying roadway markings based on the location data of the original roadway markings and the image data, the first vehicle marking module positioned behind the one or more milling tools relative to a direction of travel.

Alternate aspects of the system including wherein the roadway markings may be temporary roadway markings applied to the milled surface. The system may further include a second vehicle marking controller that is configured to receive the image data and location data from the first vehicle marking controller and a second vehicle marking module responsive to the second vehicle marking controller for applying new roadway markings on a new roadway surface based on the image data and location data. The first vehicle marking controller and the first vehicle marking module may be disposed on a single vehicle. The first vehicle marking controller, the one or more milling tools, and the first vehicle marking module may be disposed on a first vehicle, and the second vehicle marking controller and the second vehicle marking module may be disposed on a second vehicle. The system may further include a locator placement system disposed on the first vehicle for placing one or more locators on the milled surface. The location data may include one or more reference points and the locator is positioned to indicate the reference point. The reference point may indicate a position of one or more of the original roadway markings. The locator may be one or more of a passive locator and an active locator. The passive locator may be radar or magnetically detectable. The active locator may include one or more of a radio frequency identification device (RFID) device and a magnetic code. The location data may be acquired from one or more of a local positioning system (LPS), a speed sensor, a steering sensor, and an attitude sensor.

Another aspect of the disclosure is a method of applying roadway markings to roadways, including acquiring image data of original roadway markings on an original roadway surface and receiving and storing the image data and location data associated with the original roadway markings. The original roadway surface is milled to create a milled roadway surface. A new roadway surface is paved over the milled roadway surface and new roadway markings are applied on the new roadway surface based on the image data and location data.

Yet other aspects of the method includes applying temporary roadway markings to the milled roadway surface based on the location data of the original roadway markings and the image data before said forming of a new roadway surface. The location data may be acquired from one or more of a LPS, a speed sensor, a steering sensor, and an attitude sensor. The method may further include placing a locator on the milled surface. The locator may be placed to indicate a reference point. The reference point may indicate a position of one or more of the original roadway markings. The locator may be one or more of a passive locator and an active locator. The passive locator may be radar or magnetically detectable.

Further and alternative aspects and features of the disclosed principles will be appreciated from the following detailed description and the accompanying drawings. As will be appreciated, the principles related to imaging, storing and applying roadway markings in a process of milling and paving roadways as disclosed herein are capable of being carried out in other and different embodiments, and capable of modification in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagram illustrating different stages of the state of a roadway and general depictions of the machinery for producing the stages.

FIG. 2 is a side of the first vehicle shown in FIG. 1 incorporating aspects of the disclosure.

FIG. 3 is a side view of the paving machine shown in FIG. 1.

FIG. 4 is a side view of the second vehicle shown in FIG. 1 for applying roadway markings.

FIG. 5 is a flow chart showing a general description of actions executed by the first vehicle of FIG. 2.

FIG. 6 is a flow chart showing a general description of actions executed by the second vehicle of FIG. 4.

FIG. 7 shows aspects of the first general action of FIG. 5.

FIG. 8 shows aspects of the second general action of FIG. 5.

FIG. 9 shows aspects of the third general action of FIG. 5.

FIG. 10 shows aspects of the first general action of FIG. 6.

FIG. 11 shows aspects of the second general action of FIG. 6.

FIG. 12 shows aspects of the third general action of FIG. 6.

FIG. 13 is an illustration of a grid diagram for storing and representing the shapes, sizes and locations of preexisting, temporary and new roadway markings.

### DETAILED DESCRIPTION

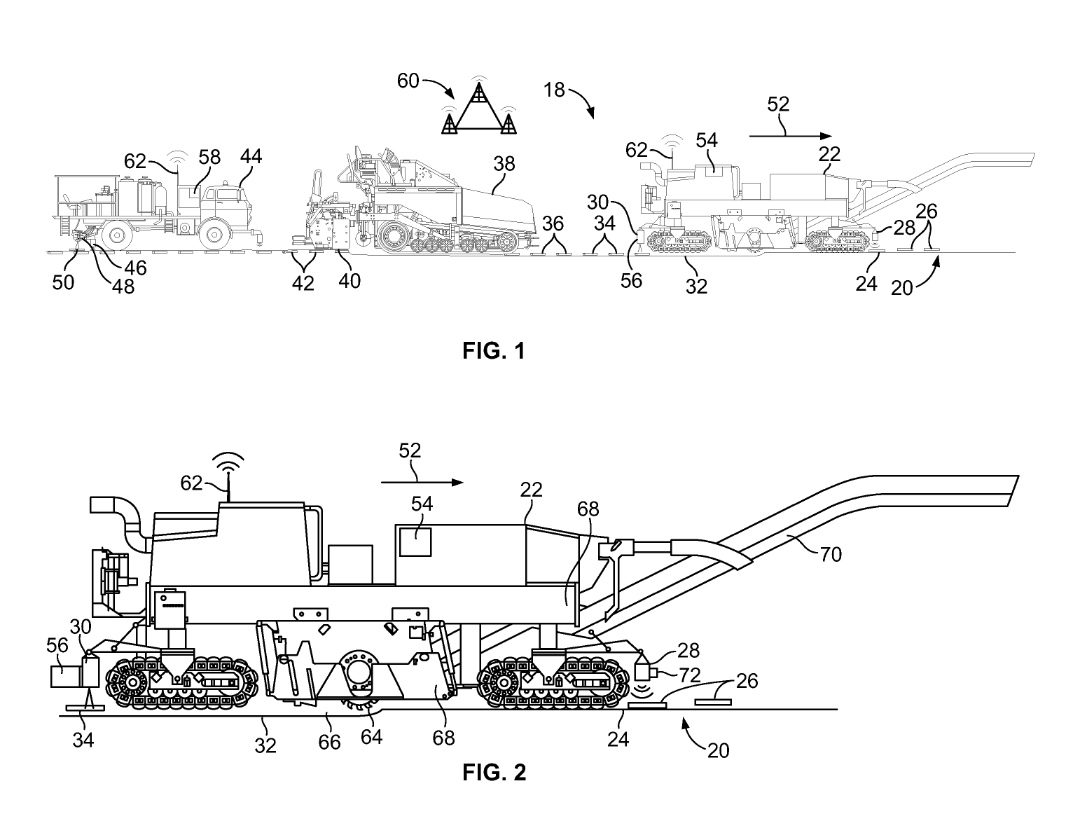

FIG. 1 is a diagram of a roadway 20 in successive states and a system 18 for producing those states described in general. Aspects of the disclosure will be set out in more detail herein. In particular, the disclosure is directed to producing states of a roadway 20 with a system 18 of imaging, storing, and reproducing roadway markings.

Roadway 20 is shown in general states with a forward direction indicated at 52. A first state of the roadway 20 includes a preexisting or original roadway surface 24 with preexisting or original roadway markings 26. A second state of the roadway 20 includes a milled surface 32 with temporary markings 34 disposed thereon and optional locators 36.

A first vehicle 22, which may be a milling machine or cold planer, works on the existing roadway surface 24 to mill material therefrom and produce the second state of the roadway 20. The third state of the roadway 20 results when a new roadway surface 40 is deposited into the milled roadway, for example, by a paving machine 38. The final state of the roadway 20 results when new roadway markings 50 are deposited on the roadway 20, preferably, based on the original roadway markings 26. A second vehicle 44 produces and deposits the new roadway markings 50. It will be understood that well-known machines are commercially available that combine the elements and functions of milling machines and paving machines. The disclosure, therefore, contemplates a single vehicle with milling, paving, and marking functions and equipment as detailed herein.

The first vehicle 22 can be of any configuration suitable for milling roadways. Relevant to the present disclosure, the first vehicle includes an imager 28 at a forward position thereof. The imager 28 is configured to and operates to detect original roadway markings 26 on original roadway 24 before the milling operation is carried out, which will destroy or otherwise obscure the original markings 26. In the illustrated embodiment, the imager 28 is a visual imager that scans and records the original roadway markings 26. The location and color of the original roadway markings 26 captured by the imager are converted to an electronic image or video file and are sent to, and stored in, a first vehicle marking controller 54.

The first vehicle marking controller 54 receives a signal or an information stream from the imager 28, which includes information indicative of the location, shape, color and, possibly other parameters such as material type and images of the original roadway markings 26. The first vehicle marking controller 54 operates a first vehicle marking module 30, which may include a conventional paint deposition system, positioned at a rear of the first vehicle 22. The first vehicle marking module 30 is operated to apply roadway markings 34, which may be temporary markings, to the milled surface 32 based on the location and color of the original roadway markings 26 that were captured by the imager 28 as the first vehicle moves along the roadway 20. The temporary markings 34 provide lane and other guidance to vehicles or pedestrians traveling, crossing, or otherwise using the milled surface 32. The temporary markings 34 may be the same as, or at least representative versions of, the original roadway markings 26. The temporary markings 34 may be circular figures or any suitable shape and size that convey the necessary information to vehicular traffic, and so on.

According to one embodiment, the first vehicle 22 may include a locator placement system 56, which can be a subsystem of the first vehicle marking module 30 or a separate system, the operation of which is controlled by the first vehicle marking controller 54. The locator placement system 56 is operated to place one or more remotely detectable locator 36 on the milled surface 32.

The placement of the remotely detectable locators 36 may be based on the original roadway markings 26 and may be associated with locations of the temporary markings 34. The remotely detectable locators 36 may have the object of indicating the location of the temporary markings 34 or may be used to indicate a reference or reference point in the roadway used by subsequent machinery to indicate the location of new roadway markings 50. Thus, the remotely detectable locators 36 may indicate start and/or end points, the center position of discreet markings, the position of boundaries or borders, the extent of the roadway and other selected reference points, features or lines.

The paving machine 38 can be of any suitable conventional configuration to produce the new surface 40. The paving performed by the paving machine 38 causes the temporary markings 34 and the locators 36 to be covered over by a new surface 40.

The second vehicle 44 can be of any suitable configuration to apply roadway markings and may include an optional sensor or sensor array 46 configured to detect the embedded remotely detectable locators 42 covered by the new surface 40. The sensor 46 may be configured to detect radio signals, magnetic elements, or radar reflections, for example. The marking vehicle 44 has a second vehicle marking module 48, which may include a conventional paint deposition system, to apply the new roadway markings 50 to the new roadway surface 40.

The second vehicle 44 includes a second vehicle marking controller 58, which may be in communication with the sensor or sensor array 46 to detect and identify the embedded remotely detectable locators 42 and control the second vehicle marking module 48 to apply the new roadway markings 50 based on the position and identification of the embedded remotely detectable locators. In one embodiment, the second vehicle marking controller 58 may be pre-loaded with an image collection or video that was acquired by the imager 28 of the first vehicle 22 when an original run over the roadway 20 was performed. Such pre-loaded information may be cross-referenced or otherwise used in conjunction with the embedded remotely detectable locators 42 to recreate the original markings on the roadway.

In one embodiment, the second vehicle marking controller 58 can use the location data and image data from the first vehicle marking controller 54 and, using a positional reference 60 provided by a local positioning system (LPS), e.g., from a pseudolite array, apply roadway markings 50 based on stored location data of the original roadway markings 26 from the first vehicle 22. Pseudolite arrays are local positioning systems that are accurate to about one centimeter. The location of each of the new roadway markings 50 is based on location data of the original roadway markings 26 detected and imaged by the imager 28 of the first vehicle. In such an embodiment, each of the first vehicle 22 and the second vehicle 44 may have a GPS antennae or wireless transceiver 62, or the like, for receiving and optionally transmitting location and other information derived from or relative to the positional reference 60 and/or to and from each other.

It will be understood that the original roadway markings 26 and the new roadway markings 50 can be any combination of conventional roadway marking shapes and colors. The temporary roadway markings 34 may be any combination of temporary roadway marking shapes and sizes, such as dots, dashes, figures, letters, numbers, lines, and so on.

The remotely detectable locators 36 may be selected from any number of objects, passive or active, that are detectable under a layer of newly applied roadway material. The remotely detectable locators 36 may be passive in that they do not actively contain or convey any more information than the fact that they are present at a given location. Examples of such passive remotely detectable locators 36 include magnetically detectable elements, radar reflective elements, and so on.

The remotely detectable locators 36 may be active in that they actively contain or convey more information than the fact that they are present. Examples of active remotely detectable locators 36 include magnetically detectable patterns or arrays, radio frequency identification (RFID) tags or devices, and the like.

The LPS may be used for autonomous operation of the first vehicle 22, paving machine 38, and the second vehicle 44, as well as other vehicles, such as rolling machines behind the paving machine. In addition, the locators 36 may also be used for autonomous operation of the paving machine, the second vehicle, and other vehicles.

FIG. 2 depicts a first vehicle 22, which operates to remove asphalt or concrete from a paved roadway (see 20 in FIG. 1). Milling tools 64, such as one or more milling drum, are attached to an underside 66 of a body or frame 68 of the first vehicle 22. The milling tools 64 operate on the original surface 24 of the roadway 20 and create a milled roadway surface 32. A conveyor 70 is configured to lift milled material from the milled roadway surface 32. The milled material may be removed and collected, or it may alternatively be processed, reconditioned or reinvigorated with additives and redeposited on the roadway. In the case of redeposition of milled material onto the roadway, the relevant structures and functions of the first and second vehicles, or the first vehicle and the paver, may be combined into a single vehicle.

The first vehicle 22 also includes an imager 28 attached to the frame 68 ahead of the machine configured to detect preexisting or original roadway markings 26, such as lane dividers, etc., on the original surface 24. The imager 28 may include one or more imaging sensor. The imager sensor may be a conventional charge coupled device (CCD) or an active pixel complementary metal-oxide-semiconductor (CMOS) sensor, having a square or rectangular array of sensor pixels. The imager 28 may collect image data and perform optical recognition to identify the shapes and sizes of original roadway markings 26 or may collect image data in a raster or pixel format, for example.

The imager 28 detects the presence, shape and color of markings on the roadway 20 and conveys the detected image data to a controller 54 where each of the image data may be associated with location data derived from the LPS 60 or some other reference. The data may be in the form of raster or other well-known formats.

The first vehicle 22 may have a sensor 72, with one or more of speed, steering, and attitude measuring capability in communication with the first vehicle marking controller 54. Information from the sensor 72 may be used by the controller to calculate the correct location or position of the temporary markings 34. Also, information from the sensor 72 may be used in an embodiment to calculate the position of markings 26 relative to an external reference (not shown). The first vehicle 22 may have well-known steering and incline or grade sensors which may be necessary to perform milling of non-horizontal surfaces such as along curving roads that have a camber. The information collected by the steering angle and incline sensors may be used to form a representation of the features of the roadway in order to accurately determine their shape and position.

Controller 54 may be connected to the sensor 72 and/or the antennae 62 for acquiring location data via direct measurement and/or data from the LPS 60. The controller 54 includes a computer operating system, program memory, a location comparator system or the like, a machine vision program and drivers and connections for operating the marking module 30. The above aspects of the controller 54 are considered well-known to those skilled in the art.

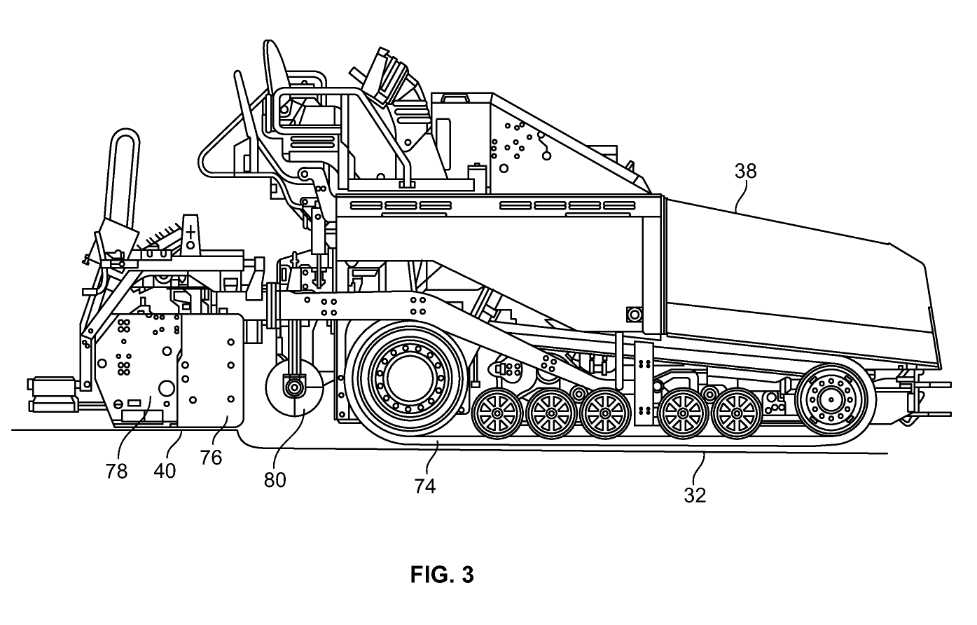

FIG. 3 is an exemplary, well-known paving machine 38. The paving machine 38 includes a track assembly 74 that pulls machine with an attached screed 76 and screed extender 78. An auger 80 is located in front of the screed 76. The paving machine 38 operates to spread a layer of new pavement surface 40 on the milled surface 32. The material that makes up the new pavement layer may be provided by a truck (not shown) depositing material into a hopper of the paving machine 38 in the known fashion.

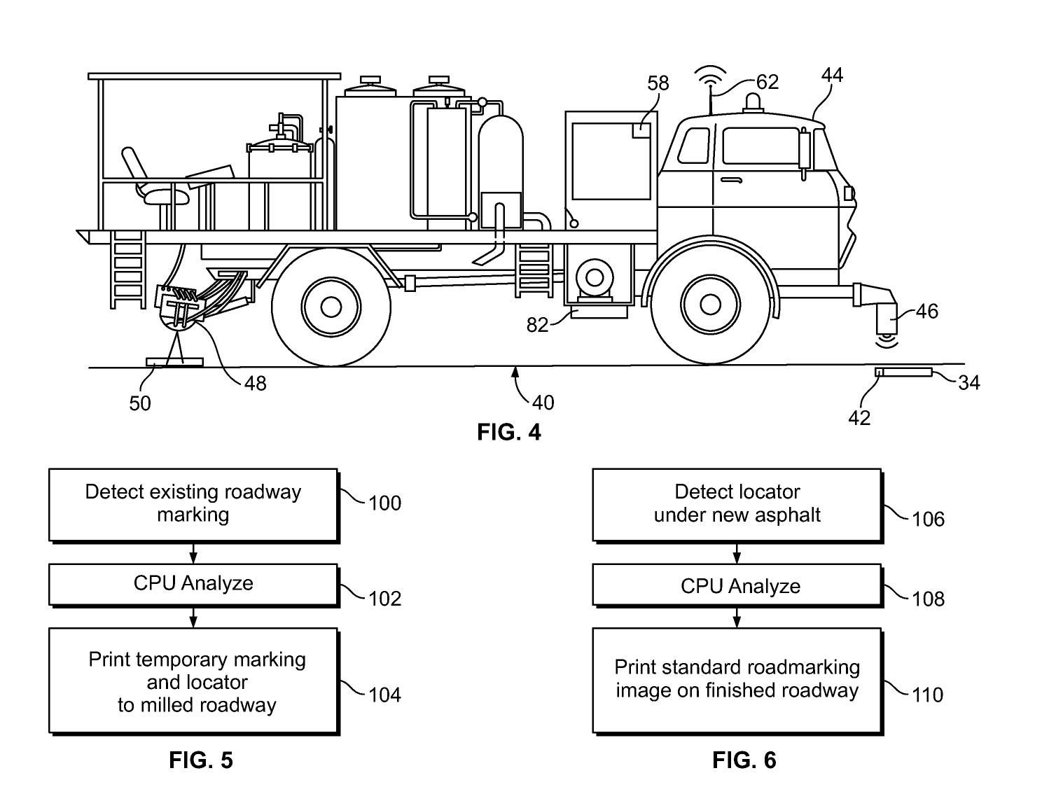

FIG. 4 shows the second vehicle 44, which may include an optional sensor or sensor array 46 configured to detect the embedded remotely detectable locators 42 covered by the new surface 40. The sensor 46 detects embedded remotely detectable locators 42 and the controller 58 uses, in one embodiment, a sensor 82, with one or more of speed, steering, and attitude measuring capability, to calculate the position of new roadway markings 50 on the new surface 40 based on at least the determined location of the embedded remotely detectable locators 42.

The second vehicle 44 has a second marking module 48 to apply the new roadway markings 50 on the new surface 40. The second vehicle 44 may, in one embodiment, have a GPS antenna or wireless transceiver 62, or the like, for receiving and optionally transmitting position and other information derived from or relative to some type of reference, such as the positional reference 60 (FIG. 1) described above. The location data can also be derived directly from the controller 54 on the first vehicle 22 (FIG. 2) and used by the second vehicle marking controller to position the new roadway markings 50 by operating the second marking module 48 accordingly.

FIG. 5, and referring to the previous figures, shows one portion of a method of detecting, storing, and applying roadway markings. Step 100 includes the detection of existing roadway markings 26 by the imager 28 of the first vehicle 22. The image data from the imager 28 and signals from the sensor 72, with one or more of speed, steering, and attitude measuring capability, is received by the first vehicle marking controller 54 and analyzed in step 102. In an alternate embodiment, location data is derived by receiving signals from a LPS 60 (FIG. 1), or another reference, to establish the location of the roadway markings 26. In step 104, a temporary marking 34 is printed or applied by the marking module 30 and, in one embodiment, a locator 36 is positioned on the milled surface 32. The locator 36 may be in the form of a passive or active locator.

FIG. 6 shows one portion of a method of applying roadway markings. Step 106 includes the detection of embedded locators 42 underneath new surface 40 of the roadway. Step 108 includes the analysis of image and location data by the second vehicle marking controller 58. Step 110 includes the application of new roadway markings 50 by the second vehicle marking module 48.

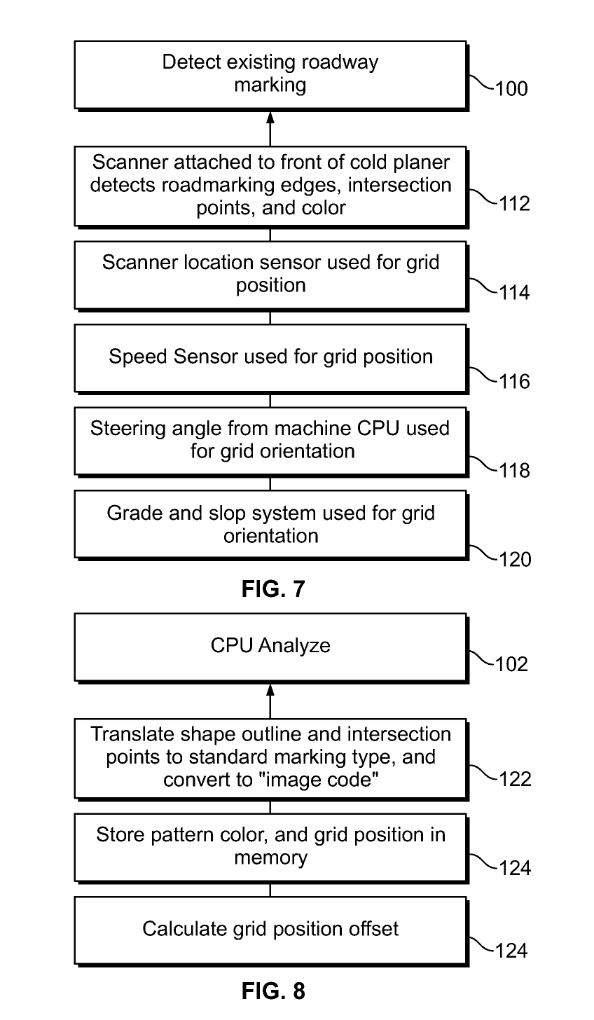

FIG. 7 shows that the imager 28, attached to the front of the first vehicle 22, detects road mark edges, intersection points, and color of the original roadway markings 26 in step 112. An LPS 60 may be used to establish a location of the markings 26 in a grid represented in the first vehicle marking controller 54 in step 114. A sensor 72, with one or more of speed, steering, and attitude measuring capability, sends signals to the first vehicle marking controller 54 to align the image data in the grid in step 116. Well-known steering angle, grade and slope sensors may be used to enhance the accuracy of the grid at step 118 and step 120. In particular, such grids are well known in the art and represent x, y, and z coordinates of a defined area. It will be understood that the first vehicle marking controller 54 compares and aligns the image data acquired from the imager 28 and the location information from the speed and grade system, and alternatively from the LPS, to assemble an image map or the like of roadway markings that is used to position temporary pavement markings 34 and the new pavement markings 50.

FIG. 8 includes the first vehicle marking controller 54, in step 122, translating the shape outline and intersection points of the existing roadway markings 26 to standard marking types and converts the image data to image code. The code is stored with color information and pattern information derived from the existing roadway markings 26 associated with the position of the existing roadway markings on the grid in the controller memory in step 124. The first vehicle marking controller 54 calculates the grid position offset of each image datum using location information from the sensor 72 or the LPS 60 at step 126.

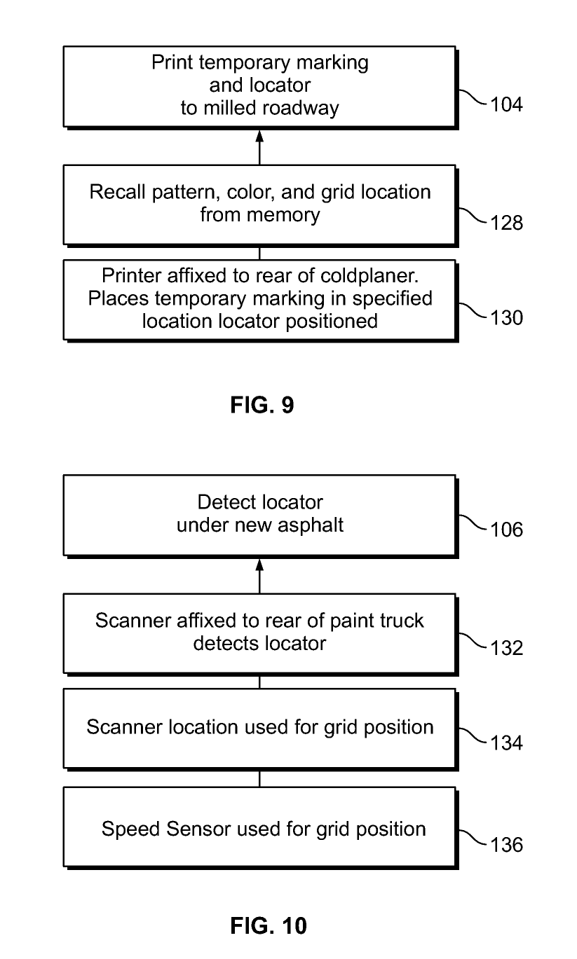

FIG. 9 includes temporary markings 34 printed/applied in step 104, and includes the first vehicle marking controller 54 sending signals to the marking module 30 corresponding to the pattern, color and grid location of the original markings 26 at 128. Step 130 includes the placement of temporary markings 34 in selected positions on the milled surface 32 corresponding to the original markings 26. Also, a locator 36, in the form of passive or active locators may be printed on the milled surface 32 in the form of or in addition to the temporary markings 34. The embedded locator 42 is detectable underneath new pavement 40 and may include information coded in the form of magnetic stripes, for example, to provide instructions for subsequent vehicles. Other locators 42 are contemplated by the disclosure as noted above.

The second vehicle 44, in one embodiment shown in FIG. 10, at step 132, includes a sensor 46 affixed to a front or rear portion of the vehicle, for example, that detects the embedded locator 42. The location of the embedded locator 42 is used, in step 134, to align to the grid location stored in the second vehicle marking controller 58. Step 136 contemplates using a sensor 82, with one or more of speed, steering, and attitude measuring capability, for the calculation of the positional offset between the sensor 46 and the second marking module 48.

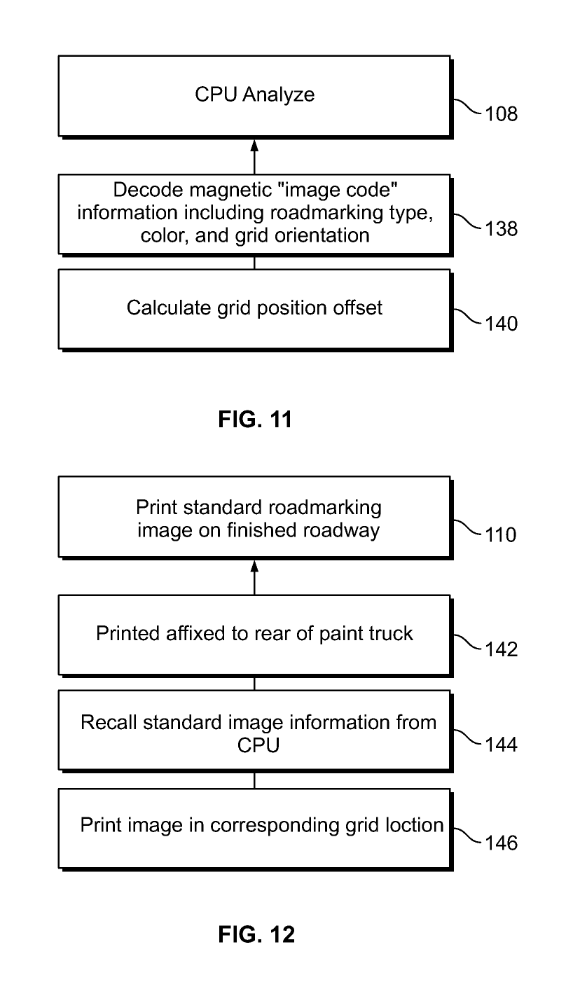

As shown in FIG. 11, step 138, information from the embedded locator 42, whether radio, magnetic and so on, is decoded by the second vehicle marking controller 58. The information may include one or more of the type of roadway marking, the color of roadway marking, and the position and/or orientation of the grid. Step 140 includes the calculation of the positional offset between the sensor 46 and the second marking module 48.

In FIG. 12, step 142, the second marking module 48 affixed to the rear of the second vehicle 44 receives instructions from the second vehicle marking controller 58 to apply roadway markings 50 to the new surface 40 at step 144 and applies the markings to the roadway based on the image data, location data and any offset derived from the speed, steering and attitude sensors in step 146.

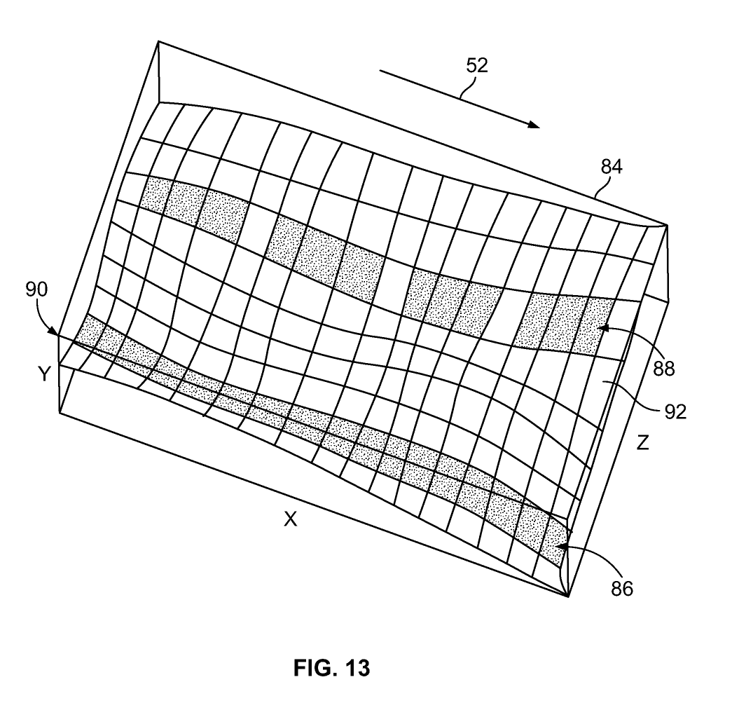

FIG. 13 is a generalized depiction of a grid system that is employed by the first and second vehicle marking controllers 54, 58. The grid 84, which may include location data arranged along X, Y, and Z axes, can be subdivided into an array of discreet areas 92. Each area 92 includes image data, in the form of values representing, for example, black, white or a different color. An example of a solid line is represented at 86 and an example of a dashed line is represented at 88. A reference point 90 may be included at an origin point (0,0), for example, and each of the other areas 92 are arranged relative to the reference point. In practice, the reference point 90 may be established with a LPS 60 base location, or a physical locator 36 or any other suitable type of reference.

### INDUSTRIAL APPLICABILITY

The present disclosure is applicable to vehicles for milling and restriping roads after a mill-and-overlay job, for example, cold milling vehicles and painting vehicles. Such machines, according to the present disclosure, employ mechanisms to acquire image and location data of existing roadway markings. The captured image and location data is used after the roadway has been milled and a new roadway formed over the milled roadway to create new roadway markings based on the image and location data. In addition, the same data can be used to apply temporary markings to the milled surface, wherein the temporary markings are based on the original roadway markings. Mechanisms are also disclosed to provide reference points that the vehicles refer to for accurate orientation of the location data.

It will be appreciated that the foregoing description provides examples of the disclosed devices. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A system for applying roadway markings to roadways, comprising:
at least one imager for acquiring image data of original roadway markings on an original roadway surface;
a first vehicle marking controller that receives and stores the image data in combination with acquired location data associated with the original roadway markings;
one or more milling tools to mill the original roadway surface and create a milled surface, the one or more milling tools positioned behind the at least one imager relative to a direction of travel; and
a first vehicle marking module responsive to the first vehicle marking controller for applying roadway markings based on the location data of the original roadway markings and the image data, the first vehicle marking module positioned behind the one or more milling tools relative to the direction of travel.

2. The system of claim 1, wherein the at least one imager, the first vehicle marking controller and the first vehicle marking module are disposed on a single vehicle, wherein the roadway markings are new roadway markings.

3. The system of claim 1, wherein the roadway markings are temporary roadway markings applied to the milled surface.

4. The system of claim 3, further comprising:
a second vehicle marking controller that is configured to receive the image data and location data from the first vehicle marking controller; and
a second vehicle marking module responsive to the second vehicle marking controller for applying new roadway markings on a new roadway surface based on the image data and location data.

5. The system of claim 4, wherein the at least one imager, the first vehicle marking controller, the one or more milling tools, and the first vehicle marking module is disposed on a first vehicle, and the second vehicle marking controller and the second vehicle marking module are disposed on a second vehicle.

6. The system of claim 5, further comprising a locator placement system disposed on the first vehicle for placing one or more locator on the milled surface.

7. The system of claim 6, wherein the location data includes one or more reference point and the one or more locator is positioned to indicate the reference point.

8. The system of claim 7, wherein the reference point indicates a position of one or more of the original roadway markings.

9. The system of claim 6, wherein the one or more locator is one or more of a passive locator and an active locator.

10. The system of claim 9, wherein the passive locator is radar or magnetically detectable.

11. The system of claim 9, wherein the active locator includes one or more of an RFID device and a magnetic code.

12. The system of claim 1, wherein the location data is acquired from one or more of a LPS, a speed sensor, a steering sensor, and an attitude sensor.

13. A method of applying roadway markings to roadways, comprising:
acquiring image data of original roadway markings on an original roadway surface;
receiving and storing the image data and location data associated with the original roadway markings;
milling the original roadway surface to create a milled roadway surface;
forming a new roadway surface over the milled roadway surface; and
applying new roadway markings on the new roadway surface based on the image data and location data.

14. The method of claim 13, further comprising:
applying temporary roadway markings to the milled roadway surface based on the location data of the original roadway markings and the image data before said forming of the new roadway surface.

15. The method of claim 13, wherein the location data is acquired from one or more of a LPS, a speed sensor, a steering sensor, and an attitude sensor.

16. The method of claim 13, further comprising placing a locator on the milled surface.

17. The method of claim 16, wherein the locator is placed to indicate a reference point.

18. The method of claim 17, wherein the reference point indicates a position of one or more of the original roadway markings.

19. The method of claim 17, wherein the locator is one or more of a passive locator and an active locator.

20. The method of claim 19, wherein the passive locator is radar or magnetically detectable.
